(19) United States
(12) Patent Application Publication
(10) Pub. No.: US 2010/0065769 A1
(43) Pub. Date: Mar. 18, 2010

(54) SLIDE VALVE

(75) Inventor: Gunter Wehr, Numbrecht-Elsenroth (DE)

Correspondence Address: THE NATH LAW GROUP, 112 South West Street, Alexandria, VA, 22314, US

(73) Assignee: WECO Armaturen GmbH, Numbrecht (DE)

(21) Appl. No.: 12/391,960

(22) Filed: Feb. 24, 2009

(30) Foreign Application Priority Data
Sep. 15, 2008 (DE) 10 2008 047 355.3

(51) Int. Cl. F16K 3/00; F16K 3/12

(52) U.S. Cl. 251/326

(57) ABSTRACT

The invention relates to a slider 1 for installation in a pipe, with a housing 2, a counter flange 3 and a sliding plate 4, wherein the housing 2 and the counter flange 3 respectively have an opening 5, the housing 2 and the counter flange 3 are connected to one another such that a common opening 5 for the pipe is provided, the sliding plate 4 is guided between the housing 2 and the counter flange 3, and the sliding plate 4 can be displaced between an open position and a closed position for the common opening 5, characterized in that the sliding plate 4 is provided with a seal 6 and the sliding plate 4 in its closed position bears against the counter flange 3 with the seal 4, or a seal 6 is provided between the sliding plate 4 and the housing 2. An improved seal between the sliding plate 4 and the counter flange 3 or between the sliding plate 4 and the housing 2 is thus achieved.

### CROSS-REFERENCE TO RELATED APPLICATIONS

This application claims the priority benefit of German patent application DE 10 2008 047 355.3 filed Sep. 15, 2008, which is hereby incorporated by reference in its entirety.

### TECHNICAL FIELD

The invention relates to a slider for installation in a pipe, with a housing, a counter flange and a sliding plate, wherein the housing and the counter flange respectively have an opening, the housing and the counter flange are connected to one another such that a common opening for the pipe is provided, the sliding plate is guided between the housing and the counter flange, and the sliding plate can be displaced between an open position and a closed position for the common opening.

### BACKGROUND OF THE INVENTION

Sliders are used for metering and closing off liquid or gaseous media as well as flowable granular or powdery substances. A plurality of sliders is known from the prior art, which are classified, for example, as shut-off gates, bulk material sliders, throttle valves or feeders, depending on their function or construction. With a slider for water pipes, for example, parts of a water pipework or a system can be blocked off (“gated off”).

From DE 197 06 575 C2 a slider is known for installation in pipes, which slider has two housing parts and can be closed off with a sliding plate, which is guided between the two housing parts. The first housing part forms a sliding board for the sliding plate surrounding its opening, which sliding board accommodates the sliding plate in its closed position. The second housing part is embodied as an annular cover surrounding its opening, which annular cover closes the sliding board so that the first housing part forms a valve chamber that adjoins the sliding board. The valve chamber encloses the sliding plate in its open position completely and furthermore has an opening for a shaft actuated by means of a spindle, wherein the sliding plate can be inserted into the valve chamber exclusively by means of the sliding bed.

This construction as well as other constructions of a slider known from the prior art have seals between the counter flange embodied as an annular cover and the sliding plate, wherein the seals are provided on the counter flange, for example, in a groove. However, embodiments of this type often have problems with the tightness of the seal. Furthermore, seals of this type provided in the counter flange are problematic with respect to seal service life and contamination of the medium by abrasive wear, in particular in the case of granular or powdery media.

In this respect, the object of the invention is to provide a slider with improved seal.

### SUMMARY OF THE INVENTION

This is achieved according to the invention by a slider for installation in a pipe, with a housing, a counter flange and a sliding plate, wherein the housing and the counter flange respectively have an opening, the housing and the counter flange are connected to one another such that a common opening for the pipes is provided, the sliding plate is guided between the housing and the counter flange, and the sliding plate can be displaced between an open position and a closed position for the common opening, characterized in that the sliding plate is provided with a seal and the sliding plate in its closed position bears against the counter flange with the seal, or a seal is provided between the sliding plate and the housing.

The invention thus takes a completely different approach, in that on the one hand the seal is provided on the sliding plate, so that the seal in the closed position of the sliding plate bears against the counter flange, or on the other hand the seal is provided between the sliding plate and the housing. An improved seal between the sliding plate and the counter flange or the sliding plate and the housing is thus achieved.

According to a further improved embodiment of the invention it is provided that the seal is provided between the sliding plate and the housing, wherein the housing or the sliding plate is provided with the seal and the sliding plate in its closed position bears against the housing with the seal. A contact pressure is thus applied, for example, caused by a medium flowing into the pipe, on the side of the sliding plate that is not provided with the seal, that is on the housing, which in general is embodied in a more stable manner than the counter flange or than the connection between the housing and the counter flange. A greater contact pressure can thus be exerted on the sliding plate in its closed position than with sliders known from the prior art, where the seal is arranged between the sliding plate and the counter flange.

According to a preferred further development of the invention it is further provided that the seal seals the opening closed by means of the sliding plate. In other words, the seal seals the opening by means of the sliding plate in the closed position of the sliding plate. It can thus be achieved that the slider closes off a pipe connected to the slider. Furthermore it is preferred that the medium flowing in the pipe can be metered through a partially closed opening.

In principle, the seal can be embodied in any desired manner. However, according to a preferred further development of the invention, it is provided that the seal is embodied in a full perimeter manner. In other words, the seal is preferably provided in a full perimeter manner on the sliding plate or on the housing, so that the seal seals the opening closed completely by means of the sliding plate.

In principle, the counter flange and the seal can have any desired form, that is, for example, they can be rectangular or oval. However, according to a preferred further development of the invention, it is provided that the counter flange and the seal are respectively embodied in an annular manner. Furthermore, it is preferred that the seal is embodied as an O-ring seal.

According to a further preferred embodiment of the invention, it is provided that the seal is arranged in a dovetailed groove. The dovetailed groove is preferably arranged in the sliding plate or in the housing.

According to a preferred further development of the invention it is furthermore provided that the slider has devices for generating a contact pressure of the seal. A further development of the invention of this type is advantageous, since through the generation of a contact pressure of the seal, the tightness of the slider, namely in the closed position of the sliding plate, can be increased.

In principle, the contact pressure of the seal can be generated in any desired manner. However, according to a preferred further development of the invention it is provided that the contact pressure of the seal can be generated by displacement of the sliding plate in its closed position. In other words, the contact pressure of the seal can be generated by transferring the sliding plate from its open position to its closed position.

According to a preferred further development of the invention, it is further provided that the devices for generating the contact pressure are embodied as a first incline of the counter flange for the positive accommodation of a beveled front free edge of the sliding plate in its closed position and as a second incline of the counter flange for the positive accommodation of a wedge on a rear end of the sliding plate in its closed position. With an embodiment of the invention of this type, the first incline of the counter flange and/or the second incline of the counter flange can be embodied as a ramp or as a chamfer of the counter flange. In other words, a device of this type permits the generation of a contact pressure of the seal on the front free edge of the sliding plate as well as on the rear end of the sliding plate, so that a particularly good fixing of the sliding plate in its closed position and a particularly good seal of the opening is achieved.

According to a further preferred embodiment of the invention, it is provided that in the closed position of the sliding plate the contact pressure of the seal can be generated by a medium flowing in the pipe. This means that preferably the medium flowing in the pipe bears against the side of the sliding plate that is not provided with the seal. With reference to the devices listed above for generating the contact pressure of the seal, the contact pressure of the seal in addition to the devices for generating the contact pressure of the seals can be generated additionally or alternatively by a medium flowing in the pipe.

The invention further relates to the use of a slider according to the previously described embodiments of the invention as an end slider, characterized in that the pipe ends at the counter flange. A use of this type of a slider according to the invention as an end slider is advantageous compared to end sliders known from the prior art, since the pipe ends at the counter flange, that is, a medium flowing in the pipe thus exerts a contact pressure on the sliding plate, which in turn according to a preferred embodiment of the invention exerts a contact pressure on the housing by means of the seal. This makes it possible to avoid, as with the sliders known from the prior art, a contact pressure being exerted on the by means of the sliding plate, which counter flange through an excessive contact pressure could be released from the connection between the housing and the counter flange.

### BRIEF DESCRIPTION OF THE DRAWINGS

The invention is described in detail below with reference to the drawing.

The drawing shows:

FIG. 1 A slider according to a first preferred exemplary embodiment of the invention in a partial view in section,

FIG. 2 A slider according to a second preferred exemplary embodiment of the invention in a partial view in section and

FIG. 3 A slider according to a third preferred exemplary embodiment of the invention in a partial view in section.

### DETAILED DESCRIPTION

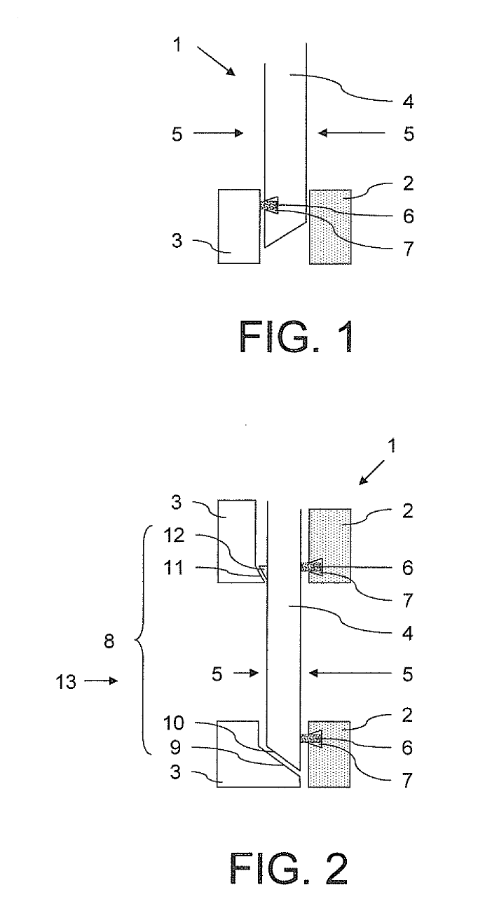

As can be seen from FIG. 1, according to a first preferred exemplary embodiment of the invention the slider 1 has a housing 2, a counter flange 3 and a sliding plate 4. The housing 2 and the counter flange 3 respectively have an opening 5 and are connected to one another such that a common opening 5 is embodied for a pipe.

As can be seen from FIG. 1, the sliding plate 4 is shown in its closed position, wherein the sliding plate 4 can be displaced between an open position and a closed position between the housing 2 and the counter flange 3 for the common opening 5. According to the first preferred exemplary embodiment of the invention, the sliding plate 4 is provided with a seal 6, wherein the sliding plate 4 in its closed position bears against the counter flange 3 with the seal 6. As furthermore can be seen from FIG. 1, the seal 6 is provided in a dovetailed groove 7 in the sliding plate 4. Furthermore, the seal 6 is embodied in a full perimeter manner. According to the preferred first exemplary embodiment of the invention, the counter flange 3 and the seal 6 are respectively embodied in an annular manner.

Because according to the present first exemplary embodiment of the invention the seal 6 is provided in the sliding plate 4, in an open position of the sliding plate 4 the seal 6 is protected against possible damage of a medium flowing in the pipe.

FIG. 2 shows the slider 1 according to the invention in a second preferred exemplary embodiment of the invention. The seal 6 is provided in a dovetailed groove 7 in the housing 2. Furthermore, the seal 6 is embodied as a ring seal. The slider 1 furthermore has devices 8 for generating a contact pressure of the seal 6.

The devices 8 for generating a contact pressure comprise a first incline 9 of the counter flange 3 for the positive accommodation of a beveled front free edge 10 of the sliding plate 4 in its closed position as well as a second incline 11 of the counter flange 3 for the positive accommodation of a wedge 12 on a rear end of the sliding plate 4. By displacement of the sliding plate 4 into its closed position, a contact pressure can be generated on the seal 6 by means of the devices 8. Furthermore, a contact pressure of the seal 6 through the medium, indicated by the arrow 13, flowing in the pipe can be generated in the closed position of the sliding plate 4.

Through arrangement of the seal 6 in a lower and upper “recess” seen relative to the pipe inside the slider 1, which, as can be seen in FIG. 2, is embodied by the housing 2 and the counter flange 3, the seal 6 in the open position of the sliding plate 4 is protected against possible damage of the medium flowing in the pipe.

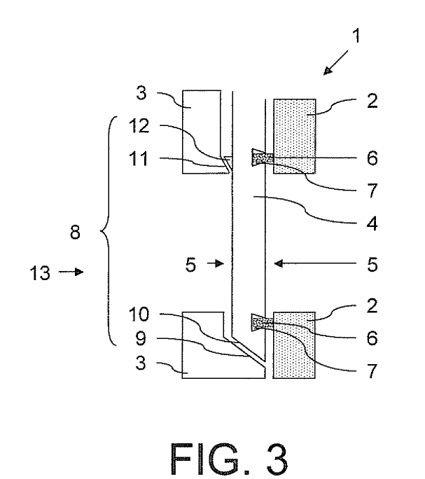

FIG. 3 shows a third preferred exemplary embodiment of the slider 1 according to the invention. As can be seen from FIG. 3, the seal 6 is arranged on the sliding plate 4 and seals with respect to the housing 2.

Because the seal 6 is provided in the sliding plate 4 according to the present third exemplary embodiment of the invention, in the open position of the sliding plate 4 the seal 6 is protected against possible damage of the medium flowing in the pipe.

Through the slider 1 according to the invention, an improved seal between the sliding plate 4 and the counter flange 3 or the sliding plate 4 and the housing 2 is achieved. In the closed position of the sliding plate 4, the seal 6 seals the opening 5.

The slider 1 can furthermore be used as an end slider, wherein the pipe ends at the counter flange 3. An end slider of this type is advantageous compared to the end sliders known from the prior art, since the pipe ends at the counter flange 3, thus a medium flowing in the pipe exerts a contact pressure on the sliding plate 4. The sliding plate 4 in turn by means of the seal 6 exerts a contact pressure on the housing 2. Thus in contrast to the end sliders known from the prior art, it is possible to avoid a contact pressure being exerted on the counter flange 3 by means of the sliding plate 4, which counter flange through an excessive contact pressure could be released from the connection between the housing 2 and the counter flange 3.

1. A slider (1) for installation in a pipe, comprising a housing (2), a counter flange (3) and a sliding plate (4), wherein the housing (2) and the counter flange (3) respectively have an opening (5), the housing (2) and the counter flange (3) are connected to one another such that a common opening (5) for the pipe is provided, the sliding plate (4) is guided between the housing (2) and the counter flange (3), and the sliding plate (4) can be displaced between an open position and a closed position for the common opening (5), characterized in that the sliding plate (4) is provided with a seal (6) and the sliding plate (4) in its closed position bears against the counter flange (3) with the seal (4), or a seal (6) is provided between the sliding plate (4) and the housing (2).

2. The slider (1) according to claim 1, wherein the seal (6) is provided between the sliding plate (4) and the housing (2), wherein the housing (2) or the sliding plate (4) is provided with the seal (6) and the sliding plate (4) in its closed position bears against the housing (2) with the seal (6).

3. The slider (1) according to claim 1, wherein the seal (6) seals the opening (5) closed by the sliding plate (4).

4. The slider (1) according to claim 1, wherein the seal (6) seals a full perimeter of the opening (5).

5. The slider (1) according to claim 1, wherein the counter flange (3) and the seal (6) are annular to each other.

6. The slider (1) according to claim 1, wherein the seal (6) is provided in a dovetailed groove (7).

7. The slider (1) according to claim 1, wherein the slider (1) has devices (8) for generating a contact pressure upon the seal (6).

8. The slider (1) according to claim 7, wherein the contact pressure upon the seal (6) can be generated by displacement of the sliding plate (4) into its closed position.

9. The slider (I) according to claim 7, wherein the devices (8) for generating the contact pressure further comprise a first incline (9) of the counter flange (3) for the positive accommodation of a beveled front free edge (10) of the sliding plate (4) in its closed position and a second incline (11) of the counter flange (3) for the positive accommodation of a wedge (12) on a rear end of the sliding plate (4) in its closed position.

10. The slider (1) according to claim 7, wherein in the closed position of the sliding plate (4), the contact pressure of the seal (6) is generated by a medium flowing in the pipe.

11. Use of a slider (1) according to claim 2 as an end slider, wherein the pipe ends at the counter flange (3).

12. Use of a slider (1) according to claim 10 as an end slider, wherein the pipe ends at the counter flange (3).
